(19) United States
(12) Patent Application Publication
(10) Pub. No.: US 2011/0223021 A1
(43) Pub. Date: Sep. 15, 2011

(54) WIND TURBINE ROTOR BLADE

(75) Inventors: Ronald Grife, Houston, TX (US); Carsten Hein Westergaard, Houston, TX (US)

(73) Assignee: VESTAS WIND SYSTEMS A/S, Randers SV (DK)

(21) Appl. No.: 13/044,209

(22) Filed: Mar. 9, 2011

Related U.S. Application Data
(60) Provisional application No. 61/312,390, filed on Mar. 10, 2010.

(51) Int. Cl. F03D 7/00

(52) U.S. Cl. 416/1; 416/23

(57) ABSTRACT

A wind turbine rotor blade is provided with a mechanism for modifying the camber of the blade. The mechanism acts over a region of the blade surface, the region including a portion of the trailing edge of the blade. Modifying the camber of the blade can increase the lift on the blade and thus the mechanism can be used to optimise blades for operation at high altitude sites where, for example, air density is lower than at sea level. Blades can be produced to the same design and then optimised for operation at differing air densities. The mechanism may be actuated mechanically or hydraulically. In the latter case the mechanism may be operated from the hub of a wind turbine.

### CROSS-REFERENCE TO RELATED APPLICATION

This application claims the benefit of U.S. Provisional Application Ser. No. 61/312,390, filed Mar. 10, 2010 and is incorporated by reference herein in its entirety.

### TECHNICAL FIELD

The invention relates to wind turbines and in particular to wind turbine rotor blades.

### BACKGROUND

A wind turbine's ability to generate power is dependent on the air density around the wind turbine. If no other factors are changed, the relationship between air density and power generation is proportional. A drop in air density will lead to a drop in power generation.

Air density is a function of temperature and pressure. Air density therefore changes on a seasonal basis and even an hourly basis in accordance with local weather patterns. Moreover, air density can vary significantly between wind turbine sites, depending, for example, on the altitude at which the sites are located.

For example, at a height of 800 meters above sea level, the air density is approximately 10 percent less than at sea level. Wind turbines are generally designed for operation at sea level. If such a wind turbine is operated at 800 meters, the annual energy production (AEP) will be reduced, depending on wind conditions, by up to approximately 3 to 10 percent. The lower figure is that for a very high wind site. It will be appreciated that high altitude sites often experience higher winds than sites at sea level. Higher winds increase energy production, but the net AEP drop is still significant. The result is a loss of revenue for the wind turbine operator and a reluctance to erect wind turbines at higher altitudes.

We have appreciated that it would be desirable to mitigate the effects of operation in differing air densities. For the above example, the potential savings, in terms of increased energy production, are considerable. For seasonal changes, the potential savings, albeit not as large, can still be significant, especially for sites subject to extreme seasonal variations.

One way of mitigating the effects of air density variation is to adjust the tip speed of the rotor blade. If the density drops by 10 percent, the tip speed would need to be increased by 3 percent to maintain the same energy output. For a fixed or semi-fixed generator this would require a different gear box, which is impractical. However, a full power converter would allow for such adjustments, but requires a complex control system. Complex designs are unattractive to wind turbine designers as they are often expensive and unreliable. Moreover, wind turbines are often erected in hostile environments where maintenance is difficult and sometimes impossible.

Another alternative is to produce a different blade design for use at higher altitudes. However, the cost of tooling and producing different blade designs is so high that this alternative is undesirable.

Therefore, what is needed is a wind turbine blade and associated methods which enable the effects of operating in differing air densities to be mitigated in a simple, robust manner.

### SUMMARY

To address these and other deficiencies, in one embodiment of the invention, a method of adjusting a wind turbine rotor blade having a blade surface includes operating a mechanism for acting over a region of the blade surface. The region includes a portion of the trailing edge of the blade and the mechanism is configured for modifying the camber of the blade at the region of the blade surface. Additionally, the trailing edge of the blade is continuous in the vicinity of the region and the operating step described above is performed prior to the blade being mounted on a wind turbine.

Preferably, operating the mechanism comprises actuating the mechanism to modify the camber of the blade at the region of the blade surface, whereby the blade when mounted on a wind turbine has a modified camber at the region of the blade surface.

Preferably, the camber of the blade is modified by the mechanism to account for air density conditions at the site at which the blade is to be mounted on the wind turbine.

According to an embodiment of the invention, there is further provided a wind turbine rotor blade comprising an upper blade surface, a lower blade surface, a leading edge, and a trailing edge. The wind turbine rotor blade further comprises a mechanism for acting over a region of one of the upper or lower blade surfaces and configured to modify the camber of the blade at the region of the one of the upper or lower surfaces of the blade. The region of the one of the upper or lower blade surfaces at which the mechanism acts includes a portion of the trailing edge of the blade. Moreover, the trailing edge of the blade is continuous in the vicinity of the region.

Modifying the camber of the blade enables the maximum lift that can be produced on the blade to be changed. Thus, embodiments of the invention have the advantage that blades can be optimised for operation in differing air densities. If a site has lower density, the maximum lift, and thus energy capture, can be increased. In addition, if a site has higher density the maximum lift can be decreased, so that the rotor design is optimal. Advantageously, decreasing lift will also decrease loading on the blades, thus reducing fatigue and the likelihood of wind turbine breakdown.

Thus, advantageously, embodiments of the invention enable blades to be produced to the same design regardless of intended location, which is cost effective, but also enable the blades to be optimised for particular local air density conditions in a simple manner.

Preferably, a plurality of the mechanisms are provided along the length of the blade, each for modifying the camber of the blade at a different region of the blade surface. This enables the camber of a blade to be modified over a larger portion of the blade and thus increase the possible change in lift.

In one embodiment, the mechanism may be actuated mechanically. Alternatively, the mechanism may be actuated hydraulically. The mechanism may be operated remotely, for example, from the hub of the wind turbine. This is particularly desirable where modifications to the camber may be required after erection, which may occur, for example, if the blade is to be optimised for seasonal variations. It is not cost effective or practical to remove the blades and is difficult to gain access to the blades in situ.

In a preferred embodiment, the blade comprises an upper surface and a lower surface, at least one of the surfaces comprising two overlapping skins, whereby the mechanism is arranged to move the skins in relation to one another thereby acting over a region of the blade surface, the region including a portion of the trailing edge of the blade, and modifying the camber of the blade at the region of the blade surface.

In an alternative embodiment, the mechanism comprises a lever arranged to act on a blade surface, the mechanism thereby acting over the region of the blade surface, the region including a portion of the trailing edge of the blade, and modifying the camber of the blade at the region of the blade surface.

Preferably, an opening is provided in the surface of the blade proximate the mechanism to provide access thereto. For example, the opening allows an operator to access the mechanism and mechanically actuate the mechanism.

Embodiments according the invention also provide a wind turbine having a rotor comprising at least one wind turbine rotor blade. The blade includes a blade surface and a mechanism for acting over a region of the blade surface, the region including a portion of the trailing edge of the blade, the mechanism configured for modifying the camber of the blade at the region of the blade surface, wherein the trailing edge of the blade is continuous in the vicinity of the region.

Preferably, the rotor comprises a hub, the camber modifying mechanism being actuatable from the hub.

### BRIEF DESCRIPTION OF THE DRAWINGS

Preferred embodiments of the invention will now be described by way of example only and with reference to the accompanying figures in which:

FIG. 1 shows a cross section of a wind turbine blade;

FIG. 2 shows a cross section of a wind turbine blade according to one embodiment of the invention;

FIG. 3 shows a plan view of a wind turbine blade;

FIG. 4 shows a cross section of a wind turbine blade;

FIG. 5 shows a similar view to FIG. 2 showing a second embodiment of the invention;

FIG. 6 shows a view similar to FIGS. 2 and 5 showing a third embodiment of the invention;

FIG. 7 shows a view similar to FIGS. 2, 5 and 6 showing a fourth embodiment of the invention;

FIG. 8 shows a modification to the embodiment of FIG. 2;

FIG. 9 shows a view similar to FIG. 2 showing a modular wind turbine blade; and

FIG. 10 shows a wind turbine having a blade according to an embodiment of the invention.

### DETAILED DESCRIPTION

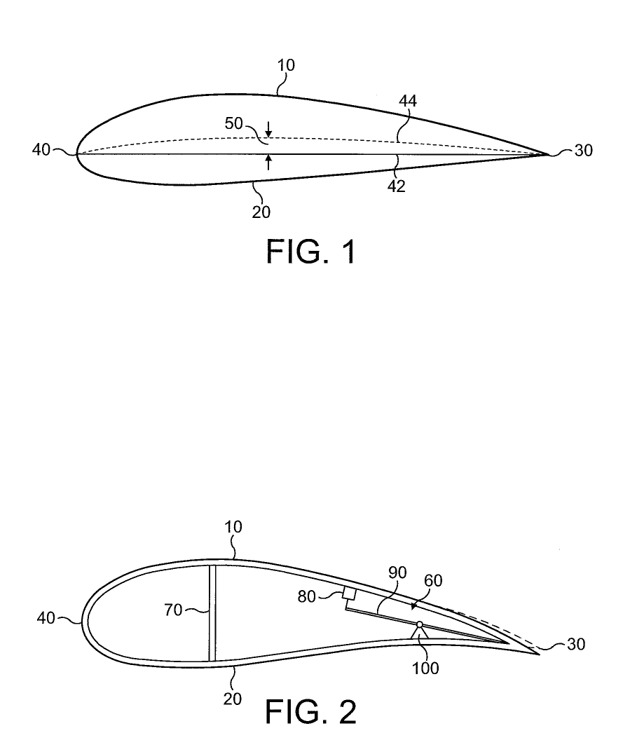

FIG. 1 shows a cross section of a wind turbine blade having an upper and a lower surface 10, 20 and a trailing and leading edge 30, 40.

As is well known in the art, the camber of a blade refers to the asymmetry between the upper and lower surfaces 10, 20 of the blade. In FIG. 1, the chord of the blade, which extends from the leading edge 40 to the trailing edge 30 of the blade, is illustrated with a solid line 42 and the camber line, which extends along the geometric centre of the blade, is indicated by a dotted line 44. The camber of the blade is the difference between the chord and the camber line 42, 44. The point of maximum camber, that is the point of maximum deviation of the chord and the median camber line, is indicated by reference numeral 50.

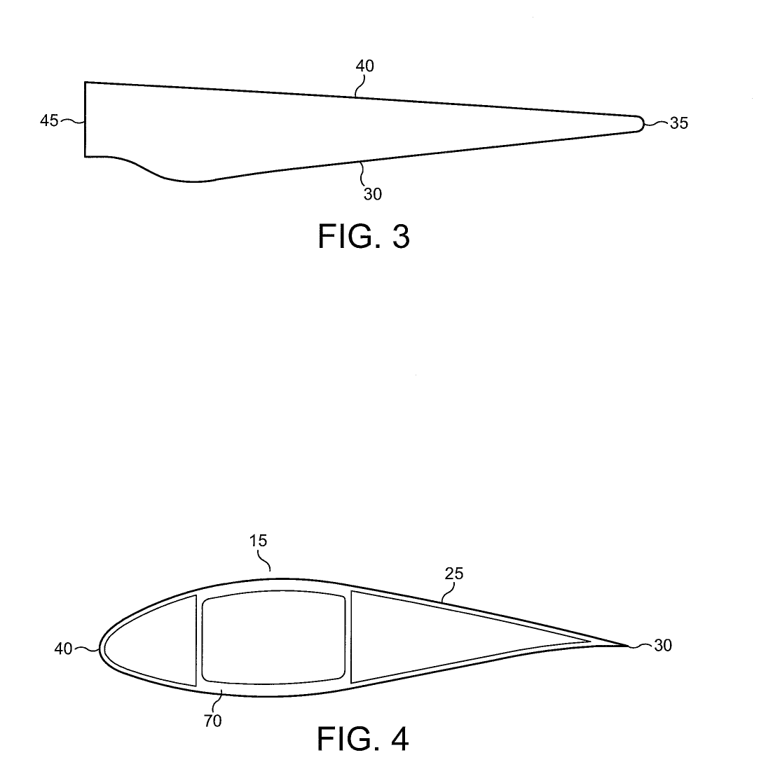

FIG. 2 illustrates a blade having a mechanism 60 for modifying the camber of the blade. The mechanism 60 acts over a region of the blade surface, the region including a portion of the trailing edge of the blade. Although a cross section of the blade at a particular point along the length of the blade is shown, it will be appreciated that the blade is several tens of metres long. FIG. 3 shows a plan view of a blade. The root of the blade 45 is the end of the blade which is connected to the hub of a wind turbine and the tip of the blade 35 is the opposite end. The trailing and leading edge 30, 40 extend from the root 45 to the tip 35 of the blade. Thus, the region over which the mechanism 60 acts includes a component along the length of the blade, that is in the spanwise direction. The region is an area of the blade surface.

One or more mechanisms 60 may be provided along the length of the blade. Preferably, the mechanisms 60 are spaced substantially equidistantly along the blade. Each mechanism 60 may adjust the camber of a local region of the blade by an individual amount or by the same amount for each mechanism 60.

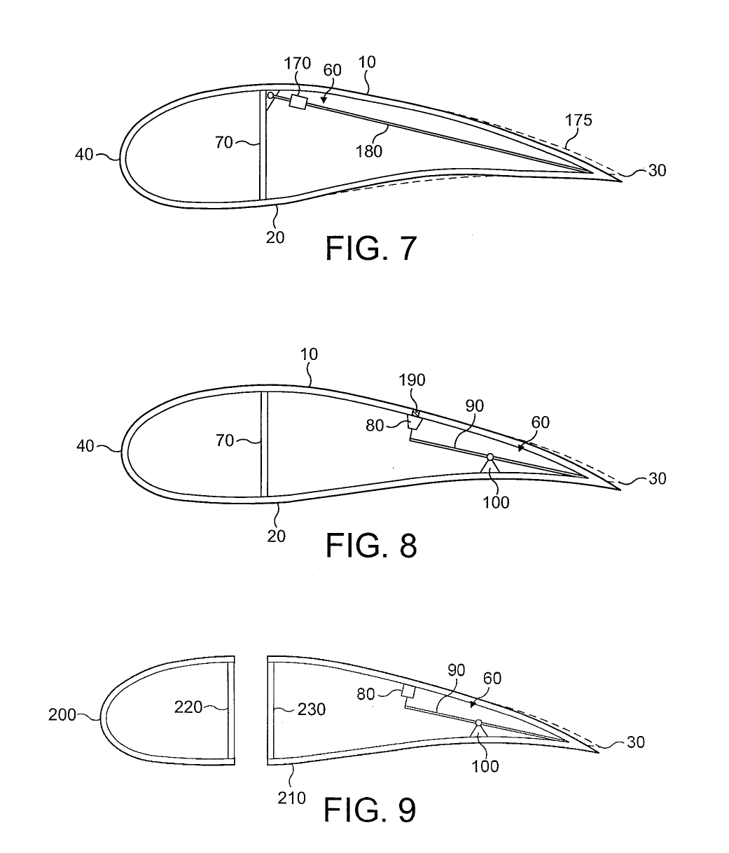

FIG. 4 illustrates a cross section of a wind turbine blade and shows a typical internal structure of a wind turbine blade. Wind turbine blades generally comprise a structurally coherent principal load bearing section 15 extending along a central portion of the blade. The load bearing section 15 may comprise one or more supporting spars 70, extending between the upper and lower surfaces 10, 20. A spar 70 is shown in FIG. 7 located towards the leading edge 40. The portion 25 aft of the structurally coherent part 15, including the trailing edge, is deformable and the region over which the mechanism 60 acts is on this aft portion 25. Thus, the aft portion 25 may deform but the structurally coherent part 15 of the blade does not deform.

The blades of commercial scale wind turbines are typically made of resiliently deformable material such as GRP (Glass Reinforced Plastics). This may be glass reinforced epoxy or polyester. The skin may be continuous over the blade surface or the blade may be modular and formed from several sections.

In the following examples, the mechanism 60 is arranged to modify the camber of the blade by modifying the position of the trailing edge 30 of the blade. Preferably, the mechanism is provided inside the blade.

In the embodiment of FIG. 2, the mechanism 60 comprises an actuation device 80 for applying a force to a lever 90. The lever 90 extends from a joint adjacent to a blade surface towards the trailing edge of the blade, where the upper and lower surfaces 10, 20 meet. The lever 90 may be a rod or any substantially rigid member.

In this example, the actuation device 80 is located on the upper surface 10 of the blade and is coupled to an end of the lever. A fulcrum 100 about which the lever 90 pivots is located on the lower surface 20 of the blade. This location of the actuation device 80 is convenient, particularly, as will be discussed with reference to FIG. 6, as it can therefore be accessed easily when an opening is provided in the upper surface of the blade.

The actuation device 80 is provided at the end of the lever 90 and the fulcrum 100 is positioned towards the centre of the lever. However, it will be appreciated that other arrangements are possible, and the position of the fulcrum, for example, may be changed depending on the forces required.

When the actuation device applies a pushing force to the lever 90, the end to which the force is applied is pushed down towards the lower surface 20. The lever 90 pivots about the fulcrum 100 and the opposite end is raised. In this case, as the opposite end is located in the trailing edge 30 of the blade, the trailing edge 30 of the blade is also raised. This causes the curvature of the upper and lower surfaces 10, 20 of the blade to be modified, as indicated by the dotted line. Thus, the mechanism 60 acts over a region of the blade. That is, although not fully shown, over a portion of the trailing edge 30 and the area of the blade surface whose curvature is thereby modified. Thus, the mechanism 60 modifies the camber of the blade at the region of the blade surface.

In order for the blade surface to be modified as described, the blade skin must be sufficiently deformable. The forces required will depend on the stiffness of the blade. The stiffness of the blade skin may need to be reduced from that of a conventional design.

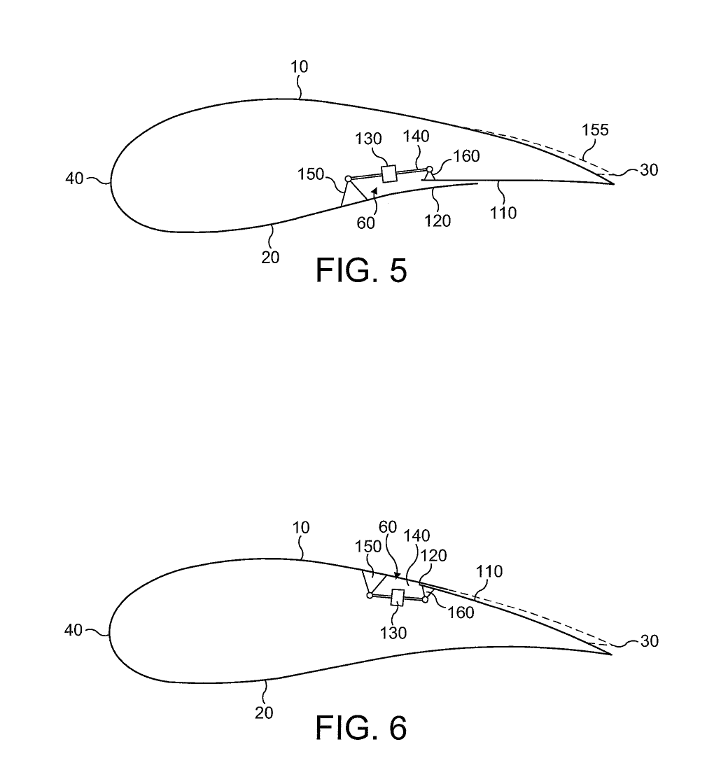

FIG. 5 illustrates a second embodiment in accordance with aspects of the invention. The lower surface 20 of the blade comprises two overlapping sheets or skins 110, 120. These skins enable the shape of the blade to be deformed easily, without stress being built up in the blade.

In this embodiment, the mechanism 60 comprises an actuation device 130 and an elongate member 140 connected at its ends, via respective fulcrums 150, 160, to the first and second skins, respectively. The mechanism thus bridges the overlap of the skins 110, 120. In this case the actuation device 130 is located such that the elongate member 140 extends from both sides of the device 130. However, this need not be the case.

The mechanism 60 is configured such that the skins forming one of the blade surfaces can be moved in relation to one another. The overlap of the sheets can therefore be increased or decreased.

When the actuation device 130 acts to lengthen the distance between the ends of the elongate member 140, the skins are moved away from one another and the overlap decreases. This forces the trailing edge 30 of the blade up. It will be appreciated that the fulcrums 150, 160 provide pivot points which allow rotational movement. Similar to the embodiment of FIG. 2, the mechanism 60 thereby acts over a region of the blade, the curvature of the upper 10 and lower 20 surfaces of the region being modified as indicated by the dotted line 155. Thus, the mechanism 60 modifies the camber of the blade at the region of the blade surface.

The third embodiment illustrated in FIG. 6 is similar to that of FIG. 5, but the mechanism 60 is arranged on the upper surface 10 rather than the lower surface 20 of the blade. The upper surface of the blade is formed with a two part overlapping skin and the mechanism 60 works in the opposite way. The trailing edge 30 of the blade moves up when the actuation device 130 acts to shorten the distance between the ends of the elongate member 140.

FIG. 7 illustrates a fourth embodiment in accordance with aspects of the invention. In this embodiment, the mechanism 60 comprises an actuation device 170 and an elongate member 180 which extends into the trailing edge 30 of the blade. In this example, the opposite end of the member 180 is held at the intersection formed by the spar 70 and the upper surface 10. The intersection provides a point against which the member 180 can be reacted. Alternatively, for example, if the blade does not comprise a spar 70, the opposite end of the member 180 could be reacted in various other locations. These locations could be internal or external.

In this case, the actuation device 170 is connected to the member 180 such that the member 180 extends on either side of the device 170. The actuation device 170 is provided towards the end of the member 180 reacted at the intersection between the spar 70 and the upper surface 10. Other locations are possible, however.

When the actuation device 170 applies a force so as to push the member 180 in the direction of the trailing edge 30 of the blade, the upper and lower surfaces of the blade curve upwards. Thus, the mechanism 60 acts over a region of the blade, the curvature of the upper 10 and lower 20 surfaces of the region being modified as indicated by the dotted line 175. It will be noted that the change in curvature of the lower surface of the blade is more prominent in this example. In any event, the mechanism 60 modifies the camber of the blade at the region of the blade surface.

Similar to the embodiment of FIG. 2, the blade skin in the embodiment of FIG. 7 must be sufficiently deformable such that the shape of the blade can be modified as described.

The mechanisms 60 may be actuated mechanically, for example, using a jack screw. Alternatively, the mechanisms 60 may be actuated hydraulically, in which case the mechanisms 60 may be actuated remotely, for example from the hub of the wind turbine. Other means of actuation are possible and will occur to a person skilled in the art. For example, the mechanism could be actuated electrically.

FIG. 8 illustrates a modification to the embodiment shown in FIG. 2. In this regard, an opening 190 is provided in the surface of the blade proximate the mechanism such that the mechanism 60 can be accessed. This facilitates the user actuating the mechanism mechanically and provides easy access to the mechanism for other reasons, for example for repair. Preferably, the opening has a removable cover so that air flow over the blade is not disrupted.

FIG. 9 illustrates how the blade may be made in a modular fashion. The blade is formed from a leading edge section 200 and a trailing edge section 210. These two sections can be assembled together by bonding or fixing the spars 220 and 230 together. The trailing edge section contains the mechanism for modifying the camber of the blade. It is important to note that FIG. 9 illustrates a simplified implementation of the invention, as the sectional element would be tailored into a complex structure of a sectionable blade.

Advantageously, the mechanisms 60 described above can be used to mitigate the effects of operation in air densities other than sea level densities, for which blades were designed. Examples of how the mechanisms 60 can be used to modify the camber of the blade have been discussed. In the examples, the camber of the blade is increased through actuation of mechanisms 60. Applying the reverse operation would decrease the camber again. It will also be appreciated that by applying appropriate forces, the camber of the blade could be modified to a greater or lesser degree.

Therefore, a single blade design can be used at multiple sites and have a modified camber at each site, so that it has the optimum aerodynamic profile for the local conditions.

For example, if the air density increases by 10 percent, the lift coefficient would need to decrease by about 5 percent for the rotor to work at optimal energy production. The amount of maximum lift change is a function of geometry and existing camber in the base line airfoil geometry. In order to achieve a 10 percent change, the camber change required is in the order of 0.5 to 1 percent, depending on the airfoil shape.

Preferably, each blade of the rotor will have one or more of the camber adjusting mechanisms 60 described above arranged along the blade. Each mechanism 60 may be used to adjust the camber by the same amount, or each mechanism 60 may be used to adjust the camber by differing amounts. The mechanisms 60 used need not be the same and may be a combination of the embodiments described above.

It is presently envisaged that approximately five mechanisms 60 will be provided. However, the number of mechanisms 60 preferred will depend on the stiffness of the skin along the blade and the length of the blade. If the skin is very compliant then the region of the blade modified by each mechanism 60 will be relatively small and more mechanisms 60 would be required to modify the camber along the same length of the blade. The skin may be re-enforced along the length of the blade such that the region of the blade modified by each mechanism 60 is increased. For example, a beam may be attached to the skin in the spanwise direction. In that case, a mechanism 60 may be provided at each end of the beam.

As is well understood in the art, the blade has a degree of twist such that the angle of attack of the leading edge 40 of the blade is steeper at the root 45 of the blade than at the tip 35. If the mechanisms 60 each adjust the camber of the blade by differing amounts, the twist of the blade will change. Thus, embodiments of the invention enable the twist distribution along the blade to be modified. Different twist distributions may be advantageous in different air densities.

One of the key parameters of wind turbine design is the selection of the optimum tip speed ratio, that is, the ratio of the blade's tip speed to the oncoming wind speed. The optimum tip speed ratio is linked to the twist of the blade and if the twist can be varied, the optimum tip speed will also be varied. According to an aspect of the invention, when the camber of the blade is changed by moving the trailing edge, this has the effect of changing the twist of the blade. Therefore, an optimum tip speed ratio can be selected.

For example, the utility line frequency in Europe is 50 Hz and in the United States the frequency is 60 Hz. It is therefore necessary to have different rotor rotational speeds on turbines in Europe or the United States, and consequently, the tip speed ratios will be different. In accordance with aspects of the invention, the same turbine can be used, and the blade can be modified by changing the camber to ensure optimal performance on both the turbine in Europe or if it is used in the United States with a different rotor rotational speed.

A modification of the airfoil geometry, as described above, may result in an effective change in blade twist where applied, thereby potentially impacting the characteristics for optimal power production, i.e., conditions for peak power coefficient. This result can be used to the designer's advantage in cases where a blade design for a specific application may be improved by such modifications.

Advantageously, embodiments according to the present invention enable blades to be produced to the same design, and then optimised, for example, for sites having different air densities or in view of seasonal air density variations.

The mechanisms 60 according to embodiments of the present invention enable the camber of the blade to be modified without creating a discontinuity in the trailing edge 30 of the blade, such as is created by operation of a flap or aileron. In these embodiments, the trailing edge 30 of the blade is continuous in the vicinity of the region of the blade surface at which the mechanism 60 modifies the camber of the blade. By continuous, we mean that there is no step change in the trailing edge 30 when the trailing edge 30 is viewed from the root or tip 45, 35 of the blade. It will be noted that a mechanism for operating a flap only acts at the hinge line about which the flap is rotated, not over the region of the blade, as in embodiments of the present invention. When a flap is operated, the camber of the blade is modified by a constant amount along the length of the blade comprising the flap, whereas, in embodiments of the present invention, the amount by which the camber of the blade is modified may vary across the region in the spanwise direction. The mechanisms 60, as disclosed herein, are not flaps or ailerons, but operate in a different manner to modify the camber.

In this regard, flaps are useful for rapidly adjusting the lift on a blade so as to prevent loads, caused by sudden gusts of wind, for example, from damaging the blades or to effect short term adjustments. However, they are disadvantageous, as turbulence is generated at the intersection of the blade and the flap, which results in noise. In addition, a complex controller, generally implemented with software, is required. Whilst these disadvantages may be overlooked when continual adjustments are required, these disadvantages may make flaps undesirable for long term operation such as is addressed by the embodiments of the present invention described herein.

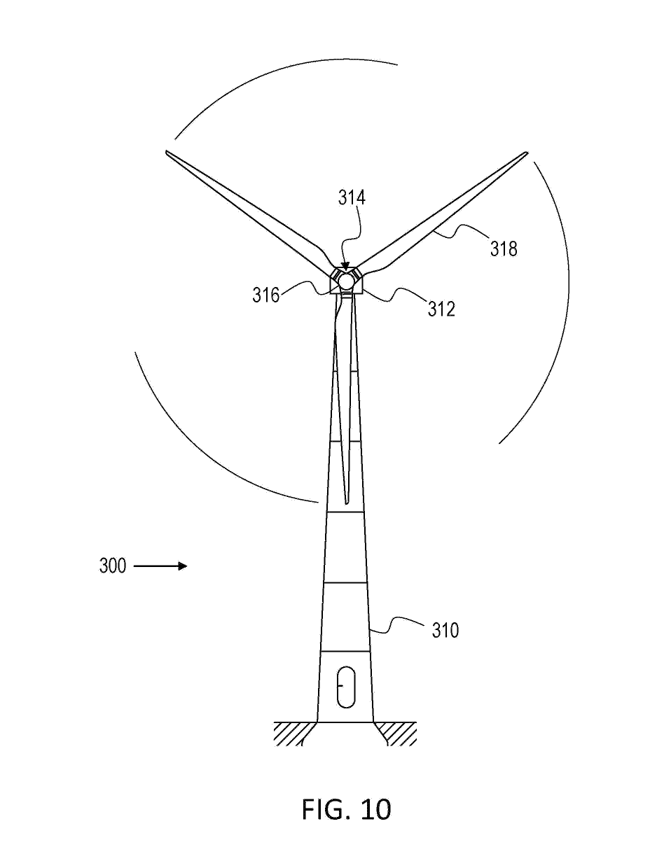

With reference to FIG. 10 and in accordance with an embodiment of the invention, the blades as disclosed above may be incorporated into a wind turbine 300. In this regard, the wind turbine 300 includes a tower 310, a nacelle 312 disposed at the apex of the tower 310, and a rotor 314 operatively coupled to a generator (not shown) housed inside the nacelle 312 for converting the kinetic energy of the wind into electrical energy. The rotor 314 includes a central hub 316 and at least one blade 318 coupled thereto and which projects outwardly from the central hub 316. The blade 318 may incorporate aspects of the invention described above to provide the noted benefits and advantages.

While the invention has been illustrated by a description of various embodiments, and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of the general inventive concept.

What is claimed is:

1. A method of adjusting a wind turbine rotor blade, the wind turbine rotor blade comprising a blade surface and a mechanism for acting over a region of the blade surface, the region including a portion of the trailing edge of the blade, the mechanism configured to modify the camber of the blade at the region of the blade surface, wherein the trailing edge of the blade is continuous in the vicinity of the region, the method comprising:
operating the mechanism to modify the camber of the blade at the region of the blade surface, wherein the operating step is performed prior to the blade being mounted on a wind turbine.

2. The method of claim 1, wherein operating the mechanism comprises actuating the mechanism to modify the camber of the blade at the region of the blade surface, whereby the blade when mounted on a wind turbine has a modified camber at the region of the blade surface.

3. The method of claim 1, wherein the camber of the blade is modified by the mechanism to account for air density conditions at the site at which the blade is to be mounted on the wind turbine.

4. The method of claim 1, wherein the blade is formed from a leading edge section and a trailing edge section, and the mechanism is located in the trailing edge section.

5. A wind turbine rotor blade, comprising:
an upper surface, a lower surface, a leading edge and a trailing edge; and
a mechanism for acting over a region of one of the upper or lower surfaces of the blade and configured to modify the camber of the blade at the region of the one of the upper or lower blade surfaces, wherein the region includes a portion of the trailing edge of the blade, and wherein the trailing edge of the blade is continuous in the vicinity of the region.

6. The wind turbine rotor blade of claim 5, wherein the mechanism is located within the blade.

7. The wind turbine rotor blade of claim 5, comprising a plurality of the mechanisms, each configured to modify the camber of the blade at a different region of the one of the upper or lower blade surfaces.

8. The wind turbine rotor blade of claim 5, wherein the mechanism is configured to be actuated mechanically.

9. The wind turbine rotor blade of claim 5, wherein the mechanism is configured to be actuated hydraulically.

10. The wind turbine rotor blade of claim 5, further comprising an opening in the one of the upper or lower blade surfaces proximate the mechanism to provide access thereto.

11. The wind turbine rotor blade of claim 5, wherein the one of the upper or lower blade surfaces comprises two overlapping skins, the mechanism being configured to move the skins in relation to one another thereby modifying the camber of the blade at the region of the one of the upper or lower blade surfaces.

12. The wind turbine rotor blade of claim 5, wherein the mechanism further comprises a lever configured to act on the one of the upper or lower blade surfaces thereby modifying the camber of the blade at the region of the one of the upper or lower blade surfaces.

13. A wind turbine, comprising:
a rotor comprising a hub and at least one wind turbine rotor blade coupled to and extending from the hub, the blade having an upper surface, a lower surface, a leading edge and a trailing edge; and
a mechanism for acting over a region of one of the upper or lower surfaces of the blade and configured to modify the camber of the blade at the region of the one of the upper or lower blade surfaces, wherein the region includes a portion of the trailing edge of the blade, and wherein the trailing edge of the blade is continuous in the vicinity of the region.

14. The wind turbine of claim 13, wherein the mechanism is configured to be actuatable from the hub.

15. The wind turbine of claim 13, wherein the mechanism is located within the blade.

16. The wind turbine of claim 13, wherein the blade includes a plurality of the mechanisms, each configured to modify the camber of the blade at a different region of the one of the upper or lower blade surfaces.

17. The wind turbine of claim 13, further comprising an opening in the one of the upper or lower blade surfaces proximate the mechanism to provide access thereto.

18. The wind turbine of claim 13, wherein the one of the upper or lower blade surfaces comprises two overlapping skins, the mechanism being configured to move the skins in relation to one another thereby modifying the camber of the blade at the region of the one of the upper or lower blade surfaces.

19. The wind turbine of claim 13, wherein the mechanism further comprises a lever configured to act on the one of the upper or lower blade surfaces thereby modifying the camber of the blade at the region of the one of the upper or lower blade surfaces.
